(19) United States
(12) Patent Application Publication
(10) Pub. No.: US 2013/0162979 A1
(43) Pub. Date: Jun. 27, 2013

(54) Measuring Method and Measuring Device for Optical Gas Measurement

(71) Applicants: Jia Chen, Rastatt (DE); Andreas Hangauer, Munchen (DE); Rainer Strzoda, Munchen (DE)

(72) Inventors: Jia Chen, Rastatt (DE); Andreas Hangauer, Munchen (DE); Rainer Strzoda, Munchen (DE)

(73) Assignee: Siemens Aktiengesellschaft, Muenchen (DE)

(21) Appl. No.: 13/394,306

(22) PCT Filed: Sep. 3, 2010
(86) PCT No.: PCT/EP2010/062919

§ 371 Date: Sep. 17, 2012

(30) Foreign Application Priority Data
Sep. 4, 2009 (DE) 10 2009 040 122.9

(51) Int. Cl. G01N 21/61

(52) U.S. Cl. CPC G01N 21/61
USPC 356/51; 356/437

(57) ABSTRACT

An optical gas measurement using a Vertical Cavity Surface-Emitting Laser (VCSEL) and a hollow waveguide connected thereto, wherein the hollow waveguide contains a gas to be measured and conducts light. To this end, the hollow waveguide is made to vibrate. The gas measurement is performed and integrated over a period of time. As a result, disturbances of the measurement caused by interferences are considerably reduced.

### CROSS-REFERENCE TO RELATED APPLICATIONS

This is a U.S. national stage of application No. PCT/EP2010/062919 filed 3 Sep. 2010. Priority is claimed on German Application No. 10 2009 040 122.9 filed 4 Sep. 2009, the content of which is incorporated herein by reference in its entirety.

### BACKGROUND OF THE INVENTION

1. Field of the Invention

The invention relates to optical gas measurements and, more particularly, to an optical gas sensor and a method for its operation, where light emitted from a light source is guided through a hollow optical wave guide.

2. Description of the Related Art

Typically, optical gas sensors use a laser diode to emit light in a measurement volume for instance. Here, the measurement volume can be represented in an embodiment of such sensors by a hollow optical wave guide. The hollow optical wave guide guides the light along its extent, if necessary also around bends, and exits the light out or reflects the light at its end to a detector.

When measuring small gas concentrations, the low absolute signal level that is provided by absorption by the gas or the gases is always problematical with optical gas sensors. Together with a comparatively great effort for signal evaluation, in which the exact wavelength position and other parameters have to be taken into account, this results in a limited accuracy of the measurement.

### SUMMARY OF THE INVENTION

It is an object of the present invention to provide device and method for allowing the resolution, i.e., the measurement accuracy, of an optical measurement to be significantly increased.

This and other objects and advantages are achieved in accordance with the invention by providing a gas measuring device with a measuring method which creates an optical gas sensor. The gas sensor has a light source, for example, a Vertical Cavity Surface-Emitting Laser (VCSEL) or a laser diode. The light emitted therefrom is guided through a hollow optical wave guide, i.e., a hollow fiber. In other words, the optical wave guide is arranged to accept the light emitted from the light source. The hollow fiber can be coupled directly to the light source and can be at a distance from the light source. The light involved is preferably infrared light, for example, in wavelengths between 2 and 10 μm, but can also be visible light. With wideband light sources, the light can have a large range of wavelengths represented.

The hollow fiber is preferably a multimode fiber which can, for example, have a diameter of 0.5 mm. Its specific volume can amount to 1.8 ml/m, for example. The hollow fiber can consist, for example, of an external jacket layer of SiO₂ and an internal, reflective coating of silver or silver iodide. The damping of the hollow fiber, for the wavelength range of 2 to 3 μm, can amount to 1.5 to 4 dB/m, with its value depending inter alia on the curvature of the fiber.

The fiber allows gases to be measured to enter its inner hollow space. The gases can enter through the ends of the fiber, for example. Entry can also be through the fiber jacket. The fiber jacket can be gas-permeable for this purpose. It can also have holes, gaps or similar openings.

At least during the passage of the light through the hollow fiber, a part of the light is absorbed by the gas present in the fiber. This absorption is determined and analyzed by a detector after the light has passed through the hollow fiber.

In accordance with the invention, vibrations are imparted to the hollow fiber at least during the measurement. Advantageously the influence of interference phenomena, which can occur, for example, with a fixed geometry as a result of reflections, are reduced. In practical terms, this can produce an improvement by a factor of 10 or more for the signal-to-noise ratio. 200 Hz can be used, for example, as a frequency for the vibrations. The amplitude of the vibrations preferably lies at several hundred μm.

The effect of the vibrations is to convert large artifacts, which occur through reflections, for example, and have a large amplitude and frequency extent, into noise with a smaller frequency extent. The additional noise can be significantly better eliminated than the previous artifacts by a curve fit of the measuring results.

In this case, it is advantageous for the hollow fiber to be connected directly to the light source. This means that the emitted light does not have to pass through any free space or has to pass though as little free space as possible before it enters the hollow fiber. In the ideal case the hollow fiber is coupled directly to the light source. This is especially advantageous when a VCSEL is used, since its radiation has a small divergence.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments are described below with reference to schematic accompanying figures. The figures show the following schematic diagrams, in which:

FIG. 1 is a block diagram of the layout of a hollow fiber;

FIG. 2 is a graphical plot illustrating a comparison between measurements with and without vibrations of the hollow fiber;

FIG. 3 a measuring layout in accordance with the invention; and

FIG. 4 is a flow chart of the method in accordance with an embodiment of the invention.

### DETAILED DESCRIPTION OF THE PREFERRED EMBODIMENTS

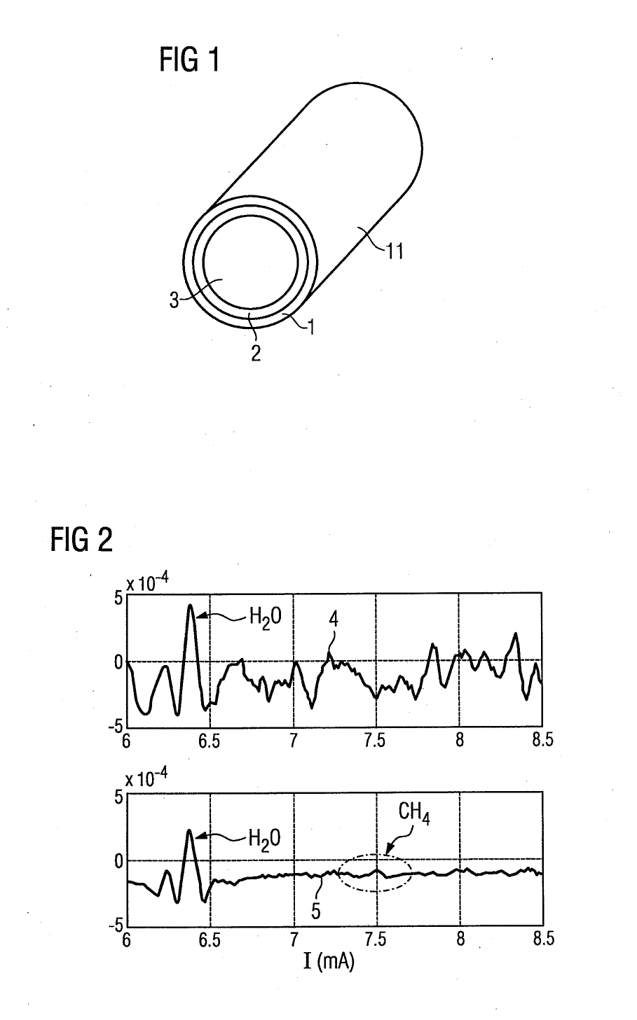

FIG. 1 shows a simplified schematic layout for a hollow fiber 11 through which the light that will be used for the measurement can be sent. The hollow fiber 11 has an envelope 1 made of silicon dioxide. Within the envelope 1 there is a layer 2 of Ag and/or AgI. The inner space 3 is hollow and filled with air or other gases. Since the light essentially moves in the inner space 3 of the hollow fiber 11, the gas to be found there is measured.

FIG. 2 shows a comparison between a first measurement 4 without and a second measurement 5 with vibrations of the hollow fiber 11. It can clearly be seen here that the strongly vibrating background created partly by interferences in the first measurement 4 without vibration of the hollow fiber 11 can cause major disruption to the evaluation. In the second measurement 5 with vibration of the hollow fiber 11 on the other hand, except for the absorption lines (in the second derivation) caused by water, at a laser current of between 6 and 6.5 mA only a little disruption is to be noticed.

The vibration of the hollow fiber 11 advantageously causes a reduction in the disruptive influence of the interferences. In this case the measurement is made advantageously over a period of time which is at least longer than the vibration period of the hollow fiber, ideally significantly longer. For example, the vibration can be performed at 200 Hz, whereas measured values are generated at 10 Hz. By an integration, averaging, or comparably combining the measured values over time, the amplitude of the noise relative to the amplitude of the signals is greatly reduced. In the example given in accordance with FIG. 2, a reduction by a factor of 10 is achieved.

The vibrations can occur in the longitudinal direction of the hollow fiber 11 or transverse to the longitudinal direction. Since the hollow fiber 11 can also be bent or even wound, it is also possible for the vibrations in different areas of the hollow fiber 11 to have different directions relative to the position of the hollow fiber 11.

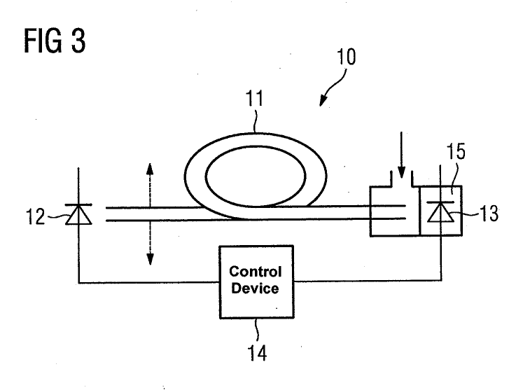

FIG. 3 shows a typical measuring layout 10. An evaluation control device 14 controls a light source in the form of a Vertical Cavity Surface Emitting Laser (VCSEL) 12 emitting at 2.3 μm. The light of the VCSEL 12 is coupled into the hollow fiber 11. There, the light travels along the extent of the hollow fiber 11 to a detector comprising an InGaAs photodiode 13. The photo diode 13 is accommodated in a housing 15. The housing 15 is filled with the gas mixture with 10% Methane (CH₄) by volume, which serves as a reference gas. The signal of photodiode 13 is received and evaluated by the evaluation and control device 14. As shown in FIG. 3, the hollow fiber 11 has a loop. Vibrations are imparted to the hollow fiber 11 in the area in which the light of the VCSEL 13 is coupled into the fiber.

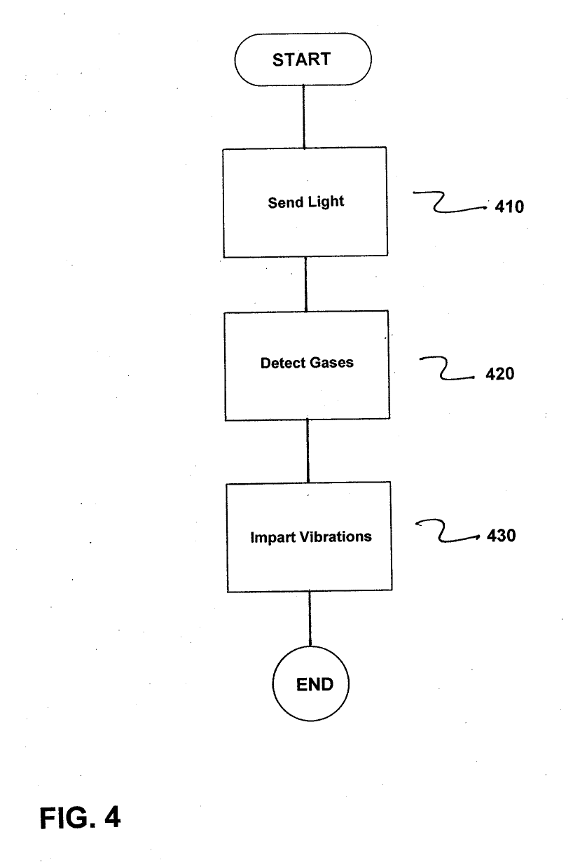

FIG. 4 is a flow chart of a method for gas detection. The method comprises sending light through a hollow waveguide having a hollow space, as indicated in step 410. Here, the hollow waveguide is configured to allow gas to enter the hollow space.

The presence of gases is detected based on absorption of parts of the light as it passes through the hollow waveguide, as indicated in step 420.

Vibrations are imparted to the hollow waveguide while the light passes through the hollow waveguide, as indicated in step 430.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A layout for gas detection, comprising:
a light source configured to emit light;
an optical waveguide comprising a hollow fiber for guiding the light, the hollow fiber having a hollow space and being configured to allow gas to enter the hollow space;
a detector configured to receive the emitted light after passage of said emitted light through the hollow fiber and configured to detect gases based on absorption of parts of the emitted light; and
a device configured to impart vibrations to the hollow fiber.

7. The layout as claimed in claim 6, wherein the hollow fiber and the light sources are connected such that the light emitted from the light source enters directly into the hollow fiber.

8. The layout as claimed in claim 6, wherein the light source emits light in an infrared or visible wavelength range.

9. A method for gas detection, comprising:
sending light through a hollow waveguide having a hollow space, the hollow waveguide being configured to allow gas to enter the hollow space;
detecting a presence of gases based on absorption of parts of the light as said light passes through the hollow waveguide; and
imparting vibrations to the hollow waveguide during passage of the light through the hollow waveguide.

10. The method as claimed in claim 9, further comprising:
performing a measurement to detect the gas detection over a period of time which is at least twice as long as a period of time during which the vibrations are imparted to the hollow waveguide.

11. The method as claimed in claim 10, wherein the measured values are integrated over the period of time.

12. The method as claimed in claim 9, wherein the light sent through the hollow waveguide is in an infrared or visible wavelength range.
